(19) United States
(12) Patent Application Publication
(10) Pub. No.: US 2013/0216879 A1
(43) Pub. Date: Aug. 22, 2013

(54) SECONDARY BATTERY

(71) Applicant: Hitachi Vehicle Energy, Ltd., (US)

(72) Inventors: Hiroaki EGAWA, Hitachinaka (JP); Takashi SASAKI, Hiratsuka (JP); Shigemi OTA, Fujisawa (JP)

(73) Assignee: Hitachi Vehicle Energy, Ltd., Hitachinaka-shi (JP)

(21) Appl. No.: 13/771,859

(22) Filed: Feb. 20, 2013

(30) Foreign Application Priority Data
Feb. 21, 2012 (JP) 2012-035324

(51) Int. Cl. H01M 10/0587

(52) U.S. Cl. CPC H01M 10/0587
USPC 429/94

(57) ABSTRACT

A battery includes a wound plate pack formed with a positive electrode comprising a positive electrode coated part having a positive foil and a positive electrode uncoated part, and a negative electrode comprising a negative electrode coated part having a negative foil and a negative electrode uncoated part; a battery container into which electrolyte is injected; a positive terminal and a negative terminal provided on the battery container; a positive current collector connecting the positive electrode uncoated part and the positive terminal; and a negative current collector connecting the negative electrode uncoated part and the negative terminal, having multiple through holes between a joining part with the positive current collector in the positive electrode uncoated part and the positive electrode coated part; and multiple through holes between a joining part with the negative current collector in the negative electrode uncoated part and the negative electrode coated part.

### FIELD OF THE INVENTION

The present invention relates to a secondary battery.

### BACKGROUND OF THE INVENTION

In recent years, large capacity (high Wh) secondary batteries have been developed as power sources for hybrid electric cars and pure electric cars and, among them, prismatic lithium ion secondary batteries which have high energy density (Wh/kg), are attracting particular interest (see Japanese Unexamined Patent Application Publication No. 2008-66254 (Patent document 1)).

In a prismatic lithium ion secondary battery, a flat shaped wound plate pack is formed by layering and winding positive electrodes each formed by coating a positive foil with positive electrode active material, negative electrodes each formed by coating a negative foil with negative electrode active material and a separator for insulating the groups of electrodes from each other. The wound plate pack is electrically connected to a positive terminal and a negative terminal disposed on the battery lid of a battery container via a positive current collector and a negative current collector. The wound plate pack is housed in a battery case in the battery container, and the opening of the battery case is sealed by and welded to the battery lid. The secondary battery is formed by injecting electrolyte through a liquid filling hole bored in the battery lid and then inserting a vent plug, which is sealed and laser-welded.

### SUMMARY OF THE INVENTION

At one end of the wound plate pack in the winding axis direction, a bundled positive electrode junction (counterpart to the positive current collector plate pack in Patent document 1) is formed, and at the other end a bundled negative electrode junction is formed. The bundled positive and negative electrode junctions are formed by crushing in advance the stacked parts of the uncoated parts of the positive and negative electrodes not coated with the positive and negative electrode active materials, respectively. The bundled positive and negative electrode junctions are respectively connected to the positive and negative current collectors (counterparts to current collecting tabs in Patent document 1) by ultrasound joining or otherwise.

Because of this configuration, the electrolyte injected into the battery container infiltrates into the wound plate pack mainly through gaps between parts other than the both ends of the positive and negative electrode junctions of the wound plate pack in the winding axis direction, namely through gaps between positive foils near a curved part on the battery lid side and near a curved part on the battery case bottom side (the opening in the wound plate pack) or gaps between negative foils (the opening in the wound plate pack).

As the area of the opening in the wound plate pack is small in the secondary battery disclosed in Patent document 1, it is difficult for the electrolyte to infiltrate well into the wound plate pack and therefore involves the problem of taking a long time for the electrolyte to be fully injected.

Incidentally, a lithium ion secondary battery may be heated by overcharging or short-circuiting and invite generation of high temperature gas within. The opening of the wound plate pack functions as not only an inlet for the electrolyte but also as a release vent for discharging out of the wound plate pack any gas generated in the wound plate pack. For this reason, there has been a desire to enhance the gas discharging performance by expanding the opening of the wound plate pack.

According to one aspect of the invention, a secondary battery includes a wound plate pack formed by winding, with a separator intervening in-between, a positive electrode provided with a positive electrode coated part having a long positive foil coated with positive electrode active material and a positive electrode uncoated part and a negative electrode provided with a negative electrode coated part having a long negative foil coated with negative electrode active material and a negative electrode uncoated part; a battery container which houses the wound plate pack and into which electrolyte is injected; a positive terminal and a negative terminal provided on the battery container; a positive current collector that connects the positive electrode uncoated part and the positive terminal; and a negative current collector that connects the negative electrode uncoated part and the negative terminal, in which multiple through holes are formed in a winding direction between a joining part with the positive current collector in the positive electrode uncoated part and the positive electrode coated part; and multiple through holes are formed in the winding direction between a joining part with the negative current collector in the negative electrode uncoated part and the negative electrode coated part.

According to another aspect of the invention, in the secondary battery described above, the through holes punched in the positive and negative electrode uncoated parts of the wound plate pack are so arrayed in the winding direction that the through holes overlap each other in adjoining layers.

According to still another aspect of the invention, in the secondary battery described immediately above, the length of the through holes, provided in the positive and negative foils, in the winding direction is greater than the length of the positive and negative foils located between a pair of through holes adjoining each other in the winding direction.

According to yet another aspect of the invention, in the secondary battery described immediately above, the through holes are in an elliptical shape of which the longer side direction is parallel, and the shorter side direction is orthogonal, to the winding direction.

According to the invention, as the total square measure of the opening of the wound plate pack as the electrolyte inlet is expanded by providing the multiple through holes, the time taken to inject electrolyte can be shortened, and thereby the productivity of the secondary battery can be enhanced. Also according to the invention, by providing the multiple through holes, the square measure of the opening of the wound plate pack as the gas outlet is expanded, and as a result any gas generated in the wound plate pack is quickly discharged out of the wound plate pack and the safety of the secondary battery can be enhanced.

### BRIEF DESCRIPTION OF THE DRAWINGS

FIG. 1 shows an external perspective view of a secondary battery pertaining to a first embodiment of the present invention;

FIG. 2 shows an exploded perspective view of the configuration of the secondary battery of FIG. 1;

FIG. 3 is a sectional schematic diagram showing a junction between the positive terminal and the positive current collector of FIG. 2;

FIG. 4 shows a perspective view of a, wound plate pack to be housed in a battery case of the secondary battery of FIG. 1;

FIGS. 5A and 5B are sectional schematic diagrams for describing the stacked structure of the wound plate pack;

FIG. 6 is a flow chart showing a procedure of fabricating the wound plate pack;

FIGS. 7A and 7B are planar schematic diagrams showing a positive foil;

FIGS. 8A and 8B are planar schematic diagrams showing a positive electrode;

FIG. 9 is a perspective view for describing a winding step.

FIG. 10 is a partially enlarged perspective view of a bundled positive electrode junction of the wound plate pack;

FIG. 11 is a planar sectional schematic diagram showing the wound plate pack;

FIGS. 12A and 12B are diagrams schematically showing a joint of positive electrode uncoated parts;

FIGS. 13A and 13B are diagrams for describing the pitch and bore of through holes;

FIG. 14 is a partially enlarged sectional schematic diagram showing Part A1 and Part A2 of FIG. 11;

FIGS. 15A and 15B are conceptual diagram showing the flow of electrolyte passing through holes;

FIG. 16 is a perspective view showing a wound plate pack to be housed in a battery container of a secondary battery, which is a second embodiment of the invention; and

FIG. 17 is a planar sectional schematic diagram of the wound plate pack of FIG. 16.

### DETAILED DESCRIPTION OF THE PREFERRED EMBODIMENTS

An embodiment to which a secondary battery according to the present invention is applied to a prismatic lithium ion battery will be described with reference to drawings.

### First Embodiment

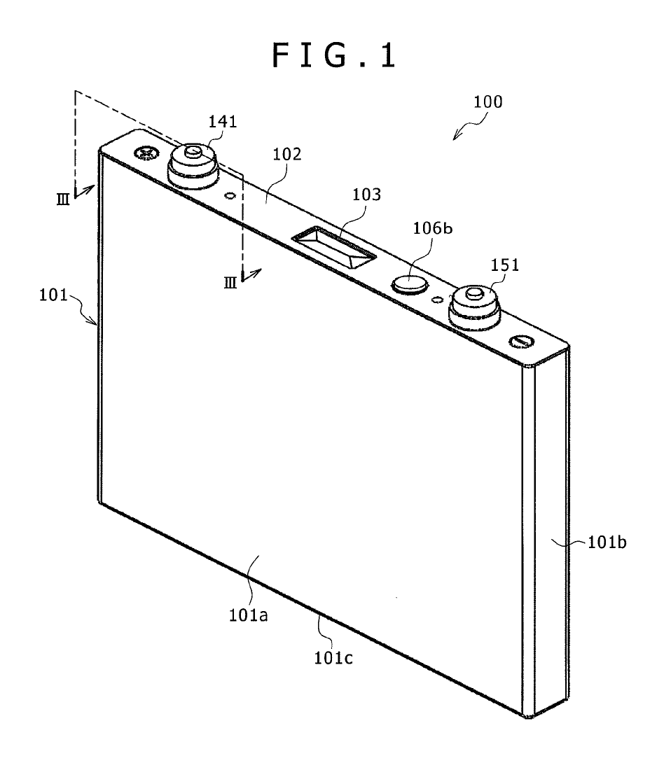

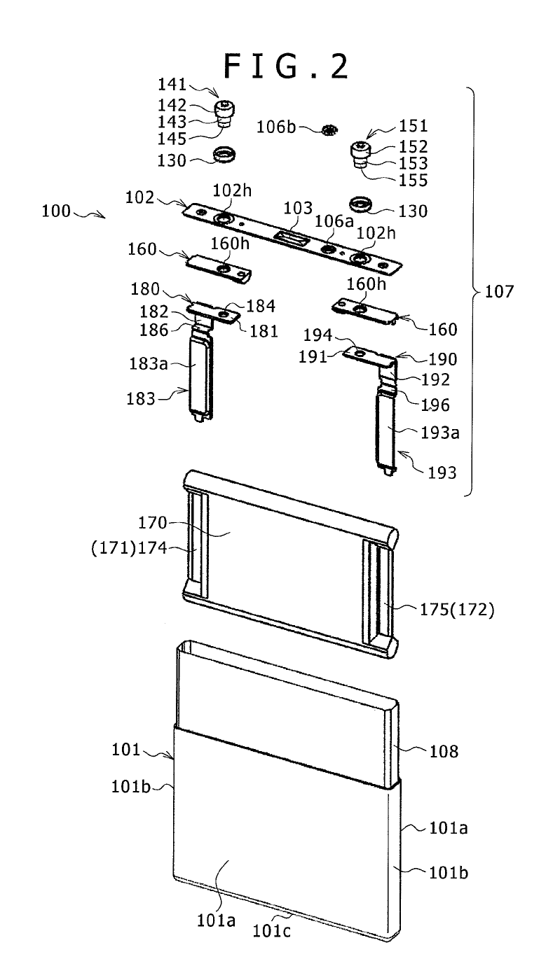

FIG. 1 is an external perspective view showing a secondary battery 100, and FIG. 2, an exploded perspective view showing the configuration of the secondary battery 100 of FIG. 1.

As shown in FIG. 1 and FIG. 2, the secondary battery 100 has a flat rectangular parallelepiped shape, and is provided with a battery container comprising a battery case 101 and a battery lid 102. The battery case 101 and the battery lid 102 are made of aluminum, aluminum alloy or the like.

As shown in FIG. 2, the battery case 101 houses a wound plate pack 170. The battery case 101 has a pair each of wide faces 101a and narrow faces 101b and a bottom face 101c, and is formed in a rectangular shape of which one end is open. The wound plate pack 170 is housed in the battery case 101 in a state of being covered by an insulating case 108. The material of the insulating case 108 is an insulative resin, such as polypropylene or polyethylene terephthalate. The bottom face and side faces of the battery case 101 are thereby electrically insulated from the wound plate pack 170.

As shown in FIG. 1 and FIG. 2, the battery lid 102, formed in a rectangular shape, is so laser-welded as to block the opening in the battery case 101. Namely, the battery lid 102 seals the battery case 101. In the battery lid 102, a positive terminal 141 and a negative terminal 151 electrically connected, respectively, to a positive electrode 174 and a negative electrode 175 of the wound plate pack 170 via a positive current collector 180 and a negative current collector 190 are arranged.

The positive terminal 141 is electrically connected to the positive electrode 174 of the wound plate pack 170 via the positive current collector 180, and the negative terminal 151 is electrically connected to the negative electrode 175 of the wound plate pack 170 via the negative current collector 190. As a result, electric power is supplied to an external load via the positive terminal 141 and the negative terminal 151, or externally generated electric power is supplied to and charges the wound plate pack 170 via the positive terminal 141 and the negative terminal 151.

As shown in FIG. 2, a filling hole 106a through which electrolyte is to be injected into the battery container is bored in the battery lid 102. The liquid filling hole 106a, as shown in FIG. 1, is sealed with a vent plug 106b after the injection of electrolyte. As the electrolyte, non-aqueous electrolyte prepared by dissolving lithium salt, such as lithium hexafluorinate (LiPF₆), in a carbonate enteric organic solvent, such as ethylene carbonate, can be used for instance.

As shown in FIG. 1 and FIG. 2, a gas release vent 103 is concavely disposed in the surface of the battery lid 102. The gas release vent 103 is formed by making the battery lid 102 partially thinner than elsewhere by such pressing as intensifies stress concentration in relative terms when an internal pressure is at work. The gas release vent 103 is cleaved, when the secondary battery 100 is heated by some abnormality, such as overcharging, to invite gas generation and the pressure in the battery container rises to a prescribed level (e.g., about 1 MPa), and discharge the gas from the inside thereby to reduce the pressure in the battery container.

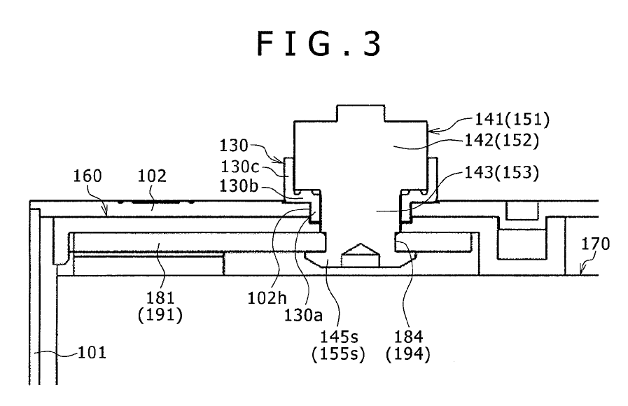

FIG. 3, which is a sectional schematic diagram showing a junction between the positive terminal 141 and the positive current collector 180 of FIG. 2, illustrates the section cut by Line III-III in FIG. 1. To add, while FIG. 3 shows the configuration on the positive electrode side, reference numerals of constituent elements on the negative electrode side are parenthesized for the sake of convenience because the positive electrode side and the negative electrode side are similar in shape and configuration. As shown in FIG. 2 and FIG. 3, by fitting the positive and negative terminals 141 and 151 and the positive and negative current collector 180 and 190 to the battery lid 102, a lid assembly 107 is formed.

As shown in FIG. 2, the lid assembly 107 comprises the battery lid 102, the positive terminal 141 and the negative terminal 151 each fitted to one or the other of paired through holes 102h bored in the battery lid 102, the positive current collector 180 and the negative current collector 190, a pair of gaskets 130 and a pair of insulating members 160.

The material of the positive terminal 141 and the positive current collector 180 is aluminum alloy. The positive terminal 141 is electrically connected to the positive current collector 180. The material of the negative terminal 151 and the negative current collector 190 is copper alloy. The negative terminal 151 is electrically connected to the negative current collector 190. The material of the insulating members 160 and the gaskets 130 is insulative resin, such as polybutylene terephthalate, polyphenylene sulfide or perfluoroalkoxy fluororesin.

As shown in FIG. 2, the pair of round through holes 102h are bored in the battery lid 102. The respective penetrating parts 143 and 153 of the positive and negative terminal 141 and 151 are inserted into the through holes 102h via the gaskets 130.

As shown in FIG. 2, the positive current collector 180 is provided with a rectangular plate-shaped terminal junction 181 arranged along the inner face of the battery lid 102, a flat plate 182 which bends at a substantially right angle from the longer side of the terminal junction 181 and extends along the wide faces 101a of the battery case 101 toward the bottom face 101c of the battery case 101, and a joining plate 183 which is connected by a linking part 186 disposed at the lower end of the flat plate 182. The joining plate 183 is a part electrically connected to the positive electrode 174 of the wound plate pack 170 by ultrasound joining, and has a joining face 183a with the positive electrode 174. In the terminal junction 181, there is bored a round through hole 184 into which a projection 145 of the positive terminal 141, to be described afterwards, is inserted. As shown in FIG. 3, the positive terminal 141 is firmly fitted to the terminal junction 181 by caulking and welding.

Similarly, as shown in FIG. 2, the negative current collector 190 is provided with a rectangular plate-shaped terminal junction 191 arranged along the inner face of the battery lid 102, a flat plate 192 which bends at a substantially right angle from the longer side of the terminal junction 191 and extends along the wide faces 101a of the battery case 101 toward the bottom face 101c of the battery case 101, and a joining plate 193 which is connected by a linking part 196 disposed at the lower end of the flat plate 192. The joining plate 193 is a part electrically connected to the negative electrode 175 of the wound plate pack 170 by ultrasound joining, and has a joining face 193a with the negative electrode 175. In the terminal junction 191, there is bored a round through hole 194 into which a project ion 145 of the negative terminal 151, to be described afterwards, is inserted. As shown in FIG. 3, the negative terminal 151 is firmly fitted to the terminal junction 191 by caulking and welding.

As shown in FIG. 3, the rectangular plate-shaped insulating members 160 are arranged between the terminal junctions 181 and 191 f the positive and negative current collectors 180 and 190, respectively, and the battery lid 102. As the insulating members 160 intervene between the terminal junctions 181 and 191 of the positive and negative current collectors 180 and 190, respectively, and the battery lid 102, both the positive and negative current collectors 180 and 190 are electrically insulated from the battery lid 102.

As shown in FIG. 2, in the insulating members 160, there are bored round through holes 160h into which the penetrating parts 143 and 153 of the positive and negative terminals 141 and 151, to be described afterwards, (see FIG. 3) are inserted.

As shown in FIG. 2 and FIG. 3, the positive terminal 141 is provided with a columnar shaped external terminal part 142, the columnar shaped penetrating part 143 projecting from one end of the external terminal part 142 toward the battery lid 102 and penetrates the through hole 102h in the battery lid 102 and the through hole 160h in the insulating members 160, and the cylindrical projection 145 (see FIG. 2) projecting from one end of the penetrating part 143 toward the wound plate pack 170. The positive terminal 141 is so formed as to be smaller in the external diameter of the penetrating part 143 than that of the external terminal part 142 and smaller in the external diameter of the projection 145 than that of the penetrating part 143. The penetrating part 143 of the positive terminal 141 is inserted into the through hole 102h in the battery lid 102 in a state in which the gasket 130 is fitted.

Similarly, as shown in FIG. 2 and FIG. 3, the negative terminal 151 is provided with a columnar shaped external terminal part 152, the columnar shaped penetrating part 153 projecting from one end of the external terminal part 152 toward the battery lid 102 and penetrating the through holes 102h of the battery lid 102 and the through holes 160h of the insulating member 160, and a cylindrical projection 155 (see FIG. 2) projecting from one end of the penetrating part 153 toward the wound plate pack 170. The negative terminal 151 is so formed as to be smaller in the external diameter of the penetrating part 153 than that of the external terminal part 152 and smaller in the external diameter of the projection 155 than that of the penetrating part 153. The penetrating part 153 of the negative terminal 151 is inserted into the through hole 102h of the battery lid 102 in a state in which the gasket 130 is fitted.

As shown in FIG. 3, the gasket 130 has a cylindrical part 130a, a ring-shaped flange part 130b extending upward from the upper end of the cylindrical part 130a, and a cylindrical cover 130c rising upward from an external edge of the flange part 130b.

The cylindrical projection 145 of the positive terminal 141 is inserted into the through hole 184 formed in the terminal junction 181 of the positive current collector 180. The flange part 130b of the gasket 130 is held between the lower end face of the external terminal part 142 and the external surface of the battery lid 102, and the tip of the cylindrical projection 145 is caulked by the terminal junction 181 of the positive current collector 180 in a state in which the lower end face of the penetrating part 143 is in contact with the terminal junction.

As a result, the terminal junction 181 of the positive current collector 180 is held between a caulking part 145s and the lower end face of the penetrating part 143, and the insulating member 160, the battery lid 102, and the flange part 130b of the gasket 130 are held between the terminal junction 181 and the lower end face of the external terminal part 142. The caulking part 145s and the terminal junction 181 are spot-welded by laser after being fixed by caulking.

Similarly, the cylindrical projection 155 of the negative terminal 151 is inserted into the through hole 194 formed in the terminal junction 191 of the negative current collector 190. The flange part 130b of the gasket 130 is held between the lower end face of the external terminal part 152 and the external surface of the battery lid 102, and the tip of the cylindrical projection 155 is caulked by the terminal junction 191 of the negative current collector 190 in a state in which the lower end face of the penetrating part 153 is in contact with the terminal junction 191.

As a result, the terminal junction 191 of the negative current collector 190 is held between a caulking part 155s and the lower end face of the penetrating part 153, and the insulating member 160, the battery lid 102, and the flange part 130b of the gasket 130 are held between the terminal junction 191 and the lower end face of the external terminal part 152. The caulking part 155s and the terminal junction 191 are spot-welded by laser after being fixed by caulking.

In this way, the positive terminal 141 is fixed to the terminal junction 181 of the positive current collector 180 by caulking and welding, and the negative terminal 151 is fixed to the terminal junction 191 of the negative current collector 190 by caulking and welding. This causes the positive current collector 180 and the positive terminal 141 to be electrically connected and the negative current collector 190 and the negative terminal 151 to be electrically connected.

The cylindrical part 130a of the gasket 130 is so arranged as to intervene between one or the other of the penetrating parts 143 and 153 of the positive and negative terminal 141 and 151 and the through hole 102h of the battery lid 102. The flange part 130b of the gasket 130 is so arranged as to intervene between the external surface of the battery lid 102 and annular end faces of the external terminal parts 142 and 152 of the positive and negative terminals 141 and 151 in a state of being compressed to a prescribed extent.

This causes the gaps between the positive and negative terminals 141 and 151 and the battery lid 102 to be sealed to secure the airtightness of the battery container. As the gaskets 130 are insulative as stated above, the positive and negative terminals 141 and 151 and the battery lid 102 are electrically insulated from each other.

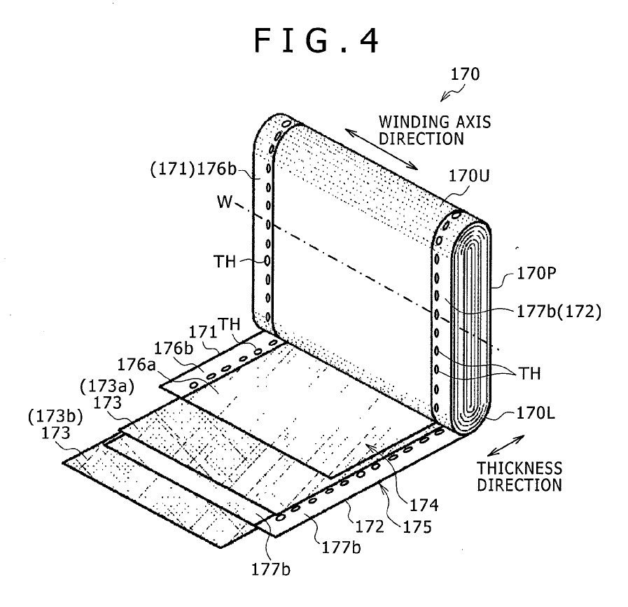

FIG. 4 shows a perspective view of a wound plate pack the wound plate pack 170 to be housed in the battery case 101 of the secondary battery 100. As shown in FIG. 4, the wound plate pack 170, which is a storage element, is formed in a stacked structure by winding the positive electrode 174 and the negative electrode 175, both long sheets, around a winding shaft W in a flat shape, with a separator 173 for insulating the electrodes intervening between them.

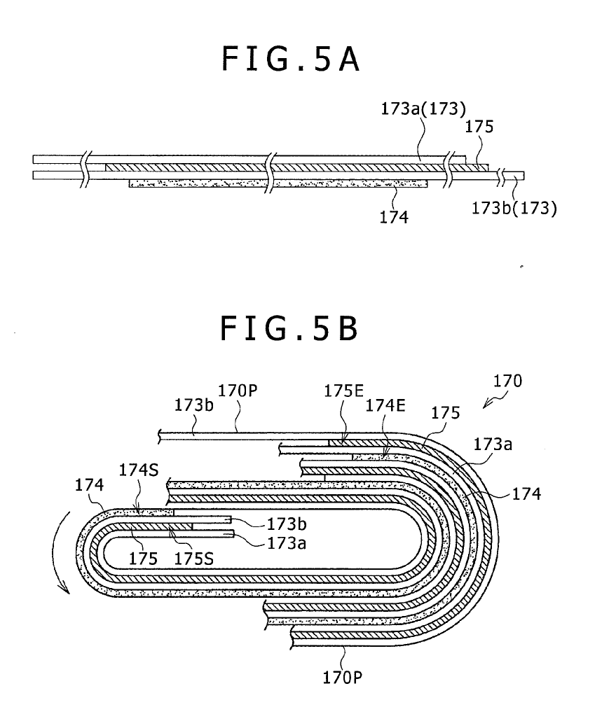

FIGS. 5A and 5B are sectional schematic diagrams for describing the stacked structure of the wound plate pack 170. The wound plate pack 170, as shown in FIG. 5A, is so wound in a flat shape as to position a sheet stack formed by sequentially stacking a long sheet-shaped separator 173a, the long sheet-shaped negative electrode 175, a long sheet-shaped separator 173b, and the long sheet-shaped positive electrode 174, to position the negative electrode 175, as shown in FIG. 5B, on the innermost wind and the outermost wind of the wound plate pack 170, and to form arc-shaped faces at both ends of the wound plate pack 170.

Referring to FIG. 5A, the negative electrode 175 is cut in a greater length than the positive electrode 174 and, as shown in FIG. 5B, the winding start edge 175S and the winding end edge 175E of the negative electrode 175 are so configured as to cover the winding start edge 174S and the winding end edge 174E of the positive electrode 174. To add, the sheet-shaped separators 173a and 173b intervene between the positive electrode 174 and the negative electrode 175, and the sheet-shaped separator 173b constitutes the external circumferential face of the wound plate pack 170. The method of manufacturing the wound plate pack 170 will be described afterwards.

The external shape of the wound plate pack 170 configured by winding the sheet stack of FIG. 5A is, as shown in FIG. 4 and FIG. 5, is a flat shape defined by arc-shaped curved faces formed at both ends and front and rear flat faces 170P continuous to the two curved faces. For the sake of convenience, the upper curved face and the lower curved face shown in FIG. 4 will be hereinafter referred to as the upper curved face 170U and the lower curved face 170L, respectively.

As shown in FIG. 4, the positive electrode 174 has a positive electrode coated part 176a coated on both faces of a positive foil 171 with a positive electrode active material mix and a positive electrode uncoated part 176b not coated on either face of the positive foil 171 with the positive electrode active material mix. The positive electrode active material mix is prepared by blending the positive electrode active material with a binder. The negative electrode 175 has a negative electrode coated part 177a coated on both faces of a negative foil 172 with a negative electrode active material mix and a negative electrode uncoated part 177b not coated on either face of the negative foil 172 with the negative electrode active material mix. The negative electrode active material mix is prepared by blending the negative electrode active material with a binder. Electric charging and discharging take place between the positive electrode active material and the negative electrode active material.

The positive foil 171 is an aluminum foil of about 20 to 30 μm in thickness, and the negative foil 172 is a copper foil of about 15 to 20 μm in thickness. The positive electrode active material is a lithium-containing transition metal double oxide such as lithium nickelate, lithium cobalt oxide, or lithium manganese oxide. The negative electrode active material is a carbonaceous material that can reversibly occlude and release lithium ions, such as non-crystalline carbon, natural graphite, or artificial graphite. The separators 173 intervening between the positive electrode 174 and the negative electrode 175 are polyethylene porous films formed of a microporous material, made up or polyethylene resin for instance, and holds electrolyte in their micropores. To add, as the material of the separators 173, a polypropylene porous film or synthetic resin unwoven cloth may be used as well.

One of the two ends of the wound plate pack 170 in the widthwise direction (the direction of the winding shaft W orthogonal to the winding direction) is used as the stacked part of the positive electrode uncoated part 176b (the exposed part of the positive foil 171) and the other, as the stacked part of the negative electrode uncoated part 177b (the exposed part of the negative foil 172).

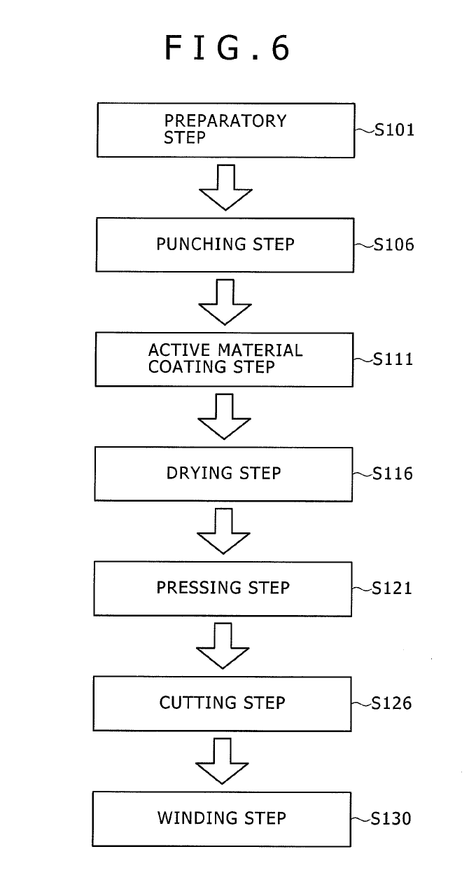

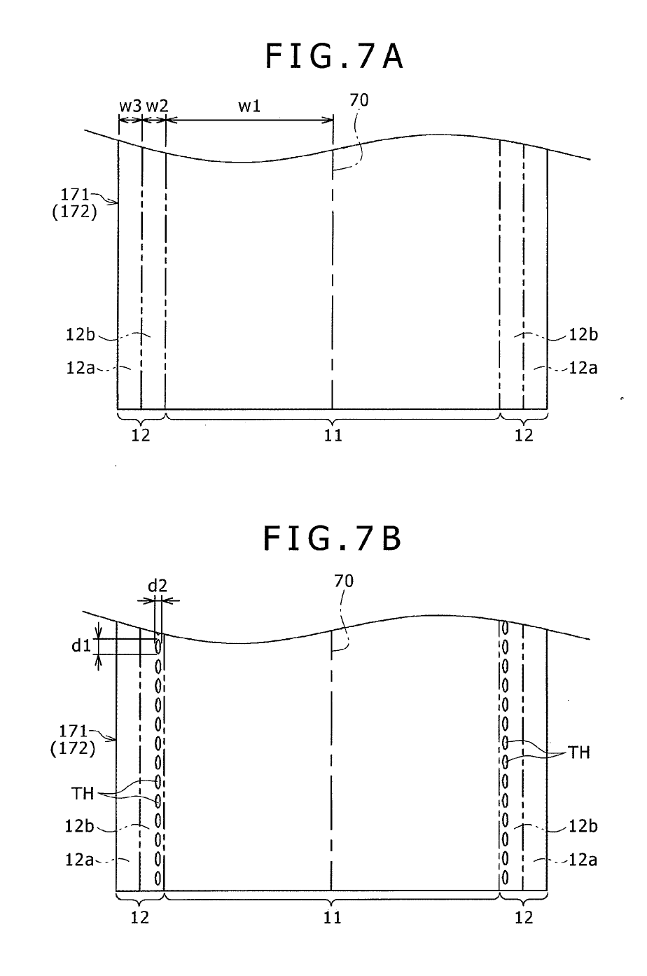

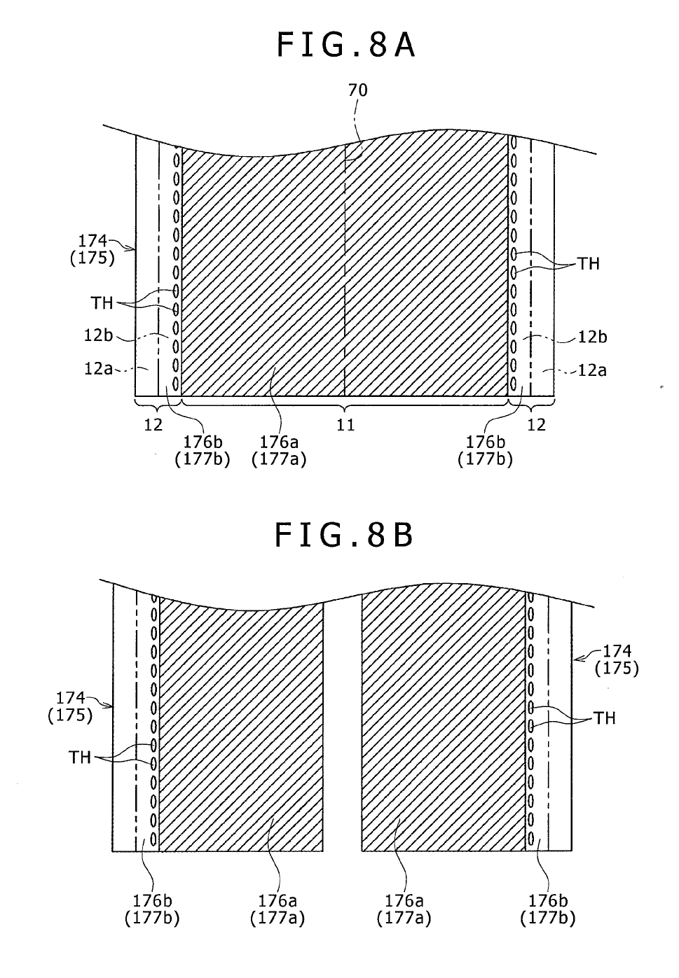

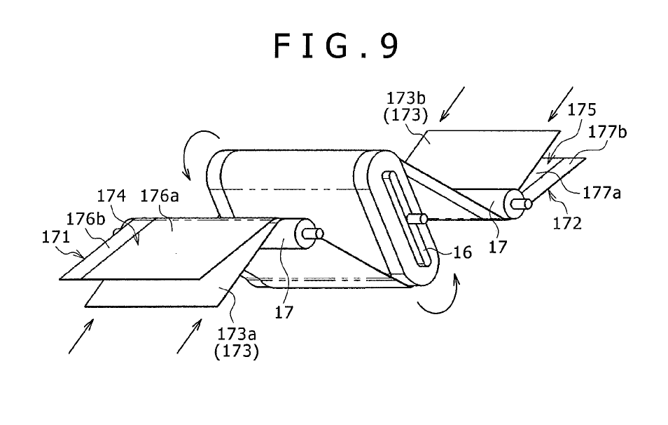

The manufacturing process of the wound plate pack 170 will be described with reference to FIG. 6 through FIG. 9. FIG. 6 is a flow chart showing the procedure of fabricating the wound plate pack 170. FIGS. 7A and 7B are planar schematic diagrams showing the positive foil 171, and FIGS. 8A and 8B are planar schematic diagrams showing the positive electrode 174. FIG. 9 is a perspective view for describing a winding step. While FIG. 7 and FIG. 8 respectively show the configurations of the positive foil and the positive electrode, as the positive foil 171 and the negative foil 172 are similar in shape though different in constituent material and the same is true of the positive electrode 174 and the negative electrode 175, reference numerals of constituent elements on the negative electrode side are parenthesized for the sake of convenience.

The positive electrode 174 is fabricated, as shown in FIG. 6, by going through a process comprising a preparatory step S101, a punching step S106, an active material coating step S111, a drying step S116, a pressing step S121, and a cutting step S126. To add, as the negative electrode 175 is fabricated through a similar process to that of the positive electrode 174 comprising steps S101 through S126, in the following description of the process of steps S101 through S126, the positive electrode 174 will represent the negative electrode 175, whose particular description will be dispensed with.

At the preparatory step S101, as shown in FIG. 7A, the positive foil 171, which is a long sheet-shaped electrode foil material double as wide as the positive electrode 174, is prepared. Reference numeral 70 in FIG. 7 and FIG. 8 denotes a dividing line in fabricating two positive electrodes 174. The dividing line 70 is an imaginary line along which one strip of positive electrode 174 is to be bisected, and is set at the center in the shorter dimensional direction of the material. At the cutting step to be described afterwards, when the positive electrode 174 is cut along the dividing line 70, this line constitutes one longer side of the positive electrode 174.

In the right and left areas in FIG. 7 with the dividing line 70 in-between, a belt-shaped active material-coated area 11 of 1×2 in width w is set, and the active material-coated area 11 is coated with the active material mix as will be described afterwards. In both right and left long side edge parts of the long positive foil 171, active material-uncoated areas 12 not coated with the active material are set.

Each of the active material-uncoated areas 12 has a joining area 12a set toward the end part (longer side) and a hole punching area 12b set between the joining area 12a and the active material-coated area 11. The joining area 12a is where the aforementioned joining plate 183 of the positive current collector 180 is joined. In the joining area 12a, a necessary width w3 for achieving electrical conduction toward the end of the positive foil 171 is secured.

In the hole punching area 12b, there is secured a width w2 for an area in which many through holes TH are to be formed as will be described afterwards. The hole punching area 12b is secured in a belt shape between the active material-coated area 11 and the joining area 12a.

At the punching step S106, as shown in FIG. 7B, holes are punched in the hole punching area 12b of the positive foil 171. When holes are punched in the hole punching area 12b, many through holes TH are formed in the positive foil 171 along the longer side of the positive foil 171, namely in the winding direction of the wound plate pack 170. The through holes TH have such an elliptical shape that the longer dimensional direction of the through holes TH is parallel to the longer side of the positive foil 171 (namely parallel to the winding direction) and the shorter dimensional direction of the through holes TH is orthogonal to the longer side of the positive foil 171 (namely orthogonal to the winding direction). The elliptical shape here may be an oval shape of which the longer axis is parallel to the longer side of the positive foil 171 and the shorter axis is orthogonal to the longer side of the positive foil 171, or a racing track shape (not shown) in which an arc is connected to each end of two straight lines parallel to the longer side of the positive foil 171. In this embodiment, as an example, the through holes TH are described as having an oval shape of which the longer axis (longer diameter) is d1 and the shorter axis (shorter diameter) is d2.

At the active material coating step S111, as shown in FIG. 8A, the active material-coated areas 11 on the two faces of the positive foil 171 are coated with the active material mix.

At the drying step S116, the applied active material mix is dried, and at the pressing step S121, an active material mix layer is pressure-molded.

At the cutting step S126, the material of the positive electrode 174 is cut along the dividing line 70, namely cut in the longer side direction at the center in the shorter side direction and, as shown in FIG. 8B, two strips of the positive electrode 174 are fabricated at the same time.

To add, as stated above, the negative electrode 175 is also fabricated through the steps S101 through S126 similar to those for the positive electrode 174.

At the winding step S130, as shown in FIG. 9, the wound plate pack 170 is fabricated by winding the positive electrode 174, the negative electrode 175, and the separators 173 while keeping them superposed one over another while providing tension by keeping them in contact with a roller (not shown).

Before winding these strips, an axial core is formed by winding the separator 173 multiple rounds around a winding shaft (core) 16 made up of polypropylene resin or the like. The negative electrode 175 is rolled in underneath the separator 173b from one side of the winding shaft 16, and the positive electrode 174 is rolled in over the separator 173a. By turning the winding shaft 16, the separator 173a, the positive electrode 174, the separator 173b, and the negative electrode 175 are wound around the axial core while being guided by horizontally installed guide rollers 17. In this winding procedure, the positive electrode uncoated part 176b and the negative electrode uncoated part 177b are arranged on mutually reverse sides.

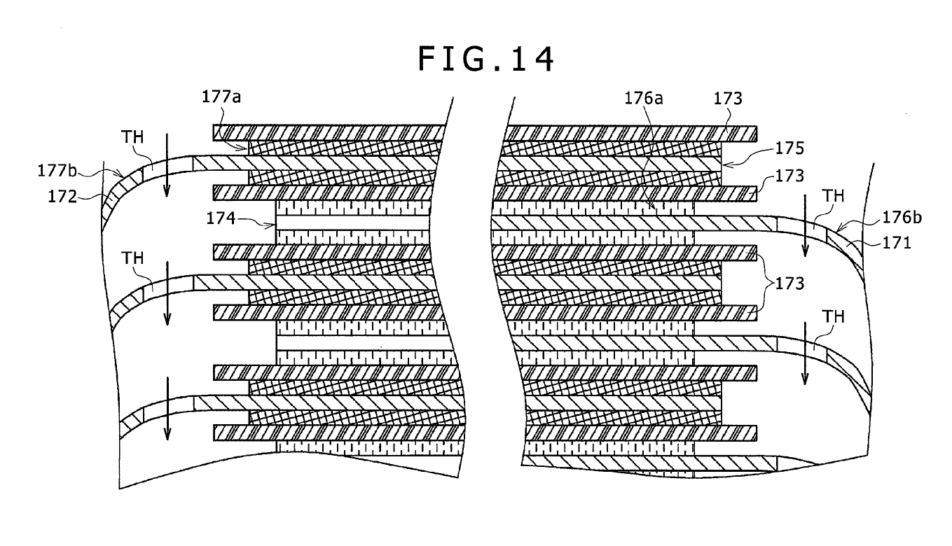

So that the positive electrode 174 may not go beyond the negative electrode 175 on the innermost wind and the outermost wind of the wound plate pack 170 in the winding direction, the length of the negative electrode 175 in the longer side direction (winding direction) is set greater than the length of the positive electrode 174 in the longer side direction (winding direction) (see FIG. 5). The length of the negative electrode coated part 177a of the negative electrode 175 in the shorter side direction (winding axis direction) is set greater than the length of the positive electrode coated part 176a of the positive electrode 174 in the shorter side direction (winding axis direction) so that the positive electrode coated part 176a may not go beyond the negative electrode coated part 177a in the shorter side direction (winding axis direction) (see FIG. 14). In the winding end part, the separator 173 is wound multiple rounds.

During the winding process, the positive electrode 174, the negative electrode 175, and both the separators 173a and 173b, while being extended as 10 N loads are applied in the lengthwise direction, are placed under such meandering control that the side face ends of the positive electrode 174, the negative electrode 175, and the separators 173a and 173b in the lengthwise direction take on constant positions.

In the wound plate pack 170 fabricated in this way, as shown in FIG. 4, the stacked part of the positive electrode uncoated part 176b is arranged at one end part in the winding axis direction, and the negative electrode uncoated part 177b is arranged at the other end part in the winding axis direction.

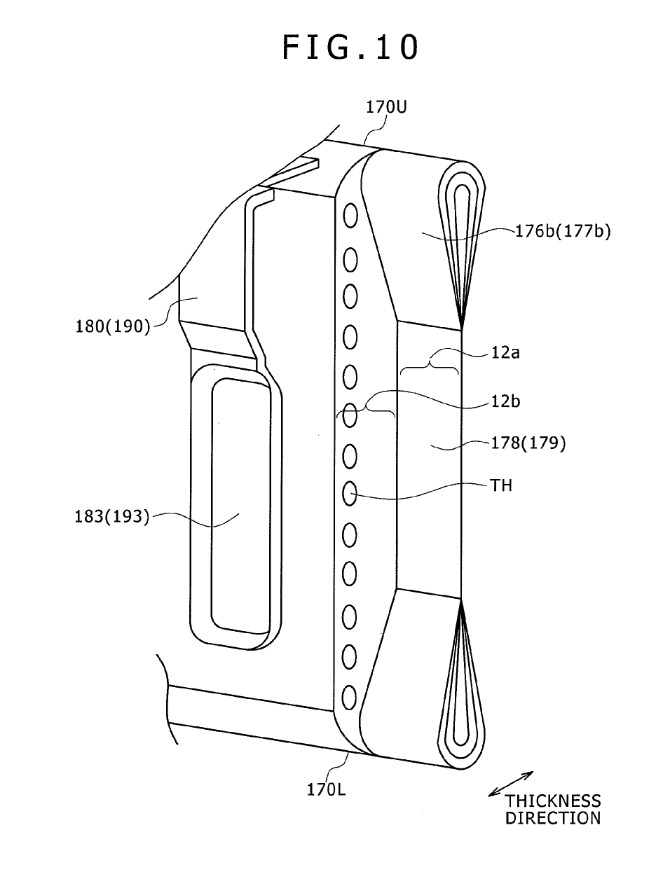

FIG. 10 is a partially enlarged perspective view of a bundled positive electrode junction 178 of the wound plate pack 170. While the configuration of the bundled positive electrode junction 178 is shown in FIG. 10, as the bundled positive electrode junction 178 and a bundled negative electrode junction 179 are similar in shape though different in constituent material, reference numerals of constituent elements on the negative electrode side are parenthesized for the sake of convenience.

The stacked part of the positive electrode uncoated part 176b is compressed in the thickness direction of the wound plate pack 170 by being crushed in advance to form the bundled positive electrode junction 178. Similarly, the stacked part of the negative electrode uncoated part 177b is compressed in the thickness direction of the wound plate pack 170 by being crushed in advance to form the bundled negative electrode junction 179.

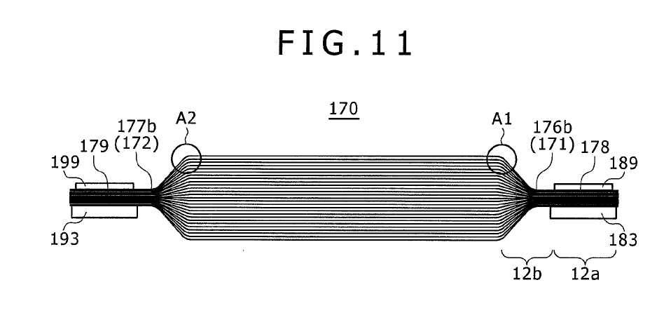

FIG. 11 is a planar sectional schematic diagram showing the wound plate pack 170. The joining plate 183 of the positive current collector 180 is ultrasonically joined to the bundled positive electrode junction 178, while the joining plate 193 of the negative current collector 190 is ultrasonically joined to the bundled negative electrode junction 179. When the bundled positive electrode junction 178 and the positive current collector 180 are to be joined, a rectangular flat protective plate 189 is used to prevent the positive foil 171 from being damaged. When the bundled negative electrode junction 179 and the negative current collector 190 are to be joined, a rectangular flat protective plate 199 is used to prevent the negative foil 172 from being damaged.

The bundled positive electrode junction 178 intervenes between the joining plate 183 and the protective plate 189, which are ultrasonically joined while being held between an ultrasound oscillating horn and an anvil (neither shown). In this way, the positive foils 171 making up the bundled positive electrode junction 178 are joined to each other and, at the same time, the bundled positive electrode junction 178, the joining plate 183 of the positive current collector 180, and the protective plate 189 are joined.

Similarly, the bundled negative electrode junction 179 intervenes between the joining plate 193 and the protective plate 199, which are ultrasonically joined while being held between an ultrasound oscillating horn and an anvil (neither shown). In this way, the negative foils 172 making up the bundled negative electrode junction 179 are joined to each other and, at the same time, the bundled negative electrode junction 179, the joining plate 193 of the negative current collector 190, and the protective plate 199 are joined.

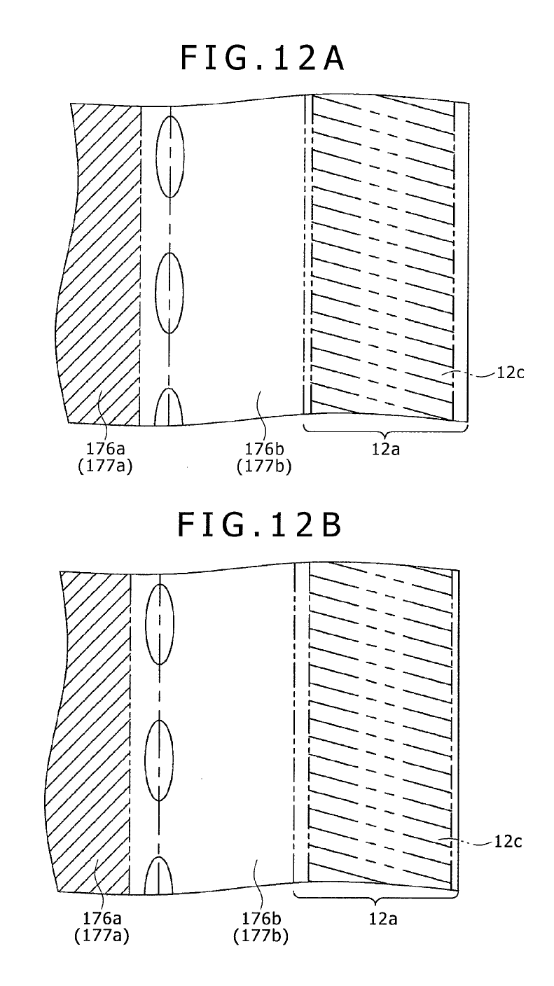

As described so far, the bundled positive and negative electrode junctions 178 and 179 are formed by crushing the stacked parts of positive and negative electrode uncoated parts 176b and 177b of the wound plate pack 170 shown in FIG. 4. For this reason, in the positions of mutual joining of the positive foils 171 and of the negative foils 172 respectively constituting the bundled positive and negative electrode junctions 178 and 179, there arise positional discrepancies of positions within the joining area 12a between the center side and the outer side of the wound plate pack 170 in the thickness direction. FIGS. 12A and 12B are diagrams schematically showing joint parts 12c of the positive electrode uncoated part 176b. FIG. 12A shows the joint part 12c of the positive electrode uncoated part 176b positioned toward the center side of the wound plate pack 170 in the thickness direction, while FIG. 12B shows the joint part 12c of the positive electrode uncoated part 176b positioned toward the outer side of the wound plate pack 170 in the thickness direction. While FIG. 12 show the configuration on the positive electrode side, reference numerals of constituent elements on the negative electrode side are parenthesized for the sake of convenience because the two sides are similar in shape and configuration though different in constituent material.

The joint part 12c of the positive electrode uncoated part 176b positioned toward the center side of the wound plate pack 170 in the thickness direction (see FIG. 12A) is positioned farther inside in the winding axis direction (toward the positive electrode coated part 176a) than the joint part 12c of the positive electrode uncoated part 176b positioned toward the outer side of the wound plate pack 170 in the thickness direction (see FIG. 12B). Similarly, the joint part 12c of the negative electrode uncoated part 177b positioned toward the center side of the wound plate pack 170 in the thickness direction is positioned farther inside in the winding axis direction (toward the negative electrode coated part 177a) than the joint part 12c of the negative electrode uncoated part 177b positioned toward the outer side of the wound plate pack 170 in the thickness direction.

The occurrence of such discrepancies of positions among the joint parts 12c is due to the crushing of the respective stacked parts of the positive and negative electrode uncoated parts 176b and 177b of the wound plate pack 170 from outside toward the center in the thickness direction as shown in FIG. 4, which cause the positive and negative electrode uncoated parts 176b and 177b positioned outside to be more greatly curved than those positioned toward the center as shown in FIG. 11.

The setting of the joining area 12a referred to above takes account of the need for a sufficient joining area to secure electrical conduction between the positive and negative current collectors 180 and 190 and the corresponding bundled positive and negative electrode junctions 178 and 179 and the discrepancy in positions among the joint part 12c positioned outside and the joint part 12c toward the center in the thickness direction.

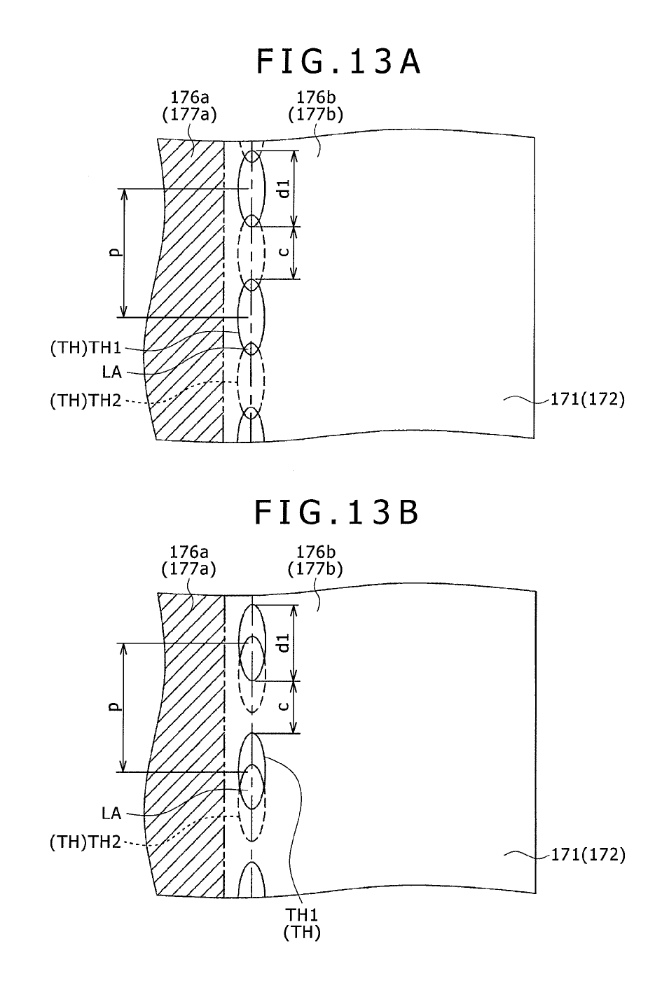

With reference to FIGS. 13A and 13B, the multiple through holes TH punched in the positive and negative electrodes 174 and 175 will be described. FIG. 13 are diagrams for describing the pitch p and bore d1 of the through holes TH. While FIG. 13 show the configuration on the positive electrode side, reference numerals of constituent elements on the negative electrode side are parenthesized for the sake of convenience because the negative electrode side has a similar shape. As shown in FIG. 13, the through holes TH punched in the positive and negative electrode uncoated parts 176b and 177b of the wound plate pack 170 are so arrayed in the winding direction that the through holes TH overlap each other.

In FIG. 13, through holes in a prescribed layer of the positive electrode uncoated part 176b of the wound plate pack 170 (see FIG. 4) are assigned a sign TH1, through holes of one layer inside than the prescribed layer of the positive electrode uncoated part 176b are assigned a sign TH2, and the through holes TH2 are represented by broken lines.

The length (bore) d1 of the through holes TH in the winding direction, namely in the direction of the longer sides of the positive and negative foils 171 and 172, are set to be longer than the length c of the positive and negative foils 171 and 172 present between a pair of through holes TH adjoining in the winding direction (d1>c). In other words, the pitch p of the through holes TH is set to a smaller value than the twofold of the length (bore) d1 of the through holes TH (p<d1×2).

In this way, as shown in FIG. 13A and FIG. 13B, an overlap area LA in which the through holes TH1 and the through holes TH2 overlap at least between adjoining layers is formed.

The electrolyte can be injected by, for instance, so placing the battery container on a flat table that the battery lid 102 comes to the top side, and fitting a jig (not shown) having two function of reducing the pressure in the battery container and injecting the electrolyte to the liquid filling hole 106a. Pressure reduction is continued until the inner pressure of the battery container comes down to 27 kPa for instance, and injecting a prescribed quantity of the electrolyte after that.

When the electrolyte is injected into the battery container, the electrolyte flows into the wound plate pack 170 through the opening in the wound plate pack 170 and, after the lapse of a prescribed length of time, the whole internal area of the wound plate pack 170 is impregnated with the electrolyte. Incidentally, to the two ends of the wound plate pack 170 in the winding axis direction, the bundled positive and negative electrode junctions 178 and 179 and the positive and negative current collectors 180 and 190 are respectively joined ultrasonically, and the positive foils 171 in the joining part or the negative foils 172 in the joining part are adhered to each other.

As the opening in the wound plate pack 170, at the two ends of the wound plate pack 170 in the winding axis direction, gaps between the positive foils 171 and gaps between the negative foils 172 are secured in other parts than the bundled positive and negative electrode junctions 178 and 179, namely in the vicinities of the curved part on the battery lid 102 side and in the vicinities of the curved part on the battery case bottom face 101c side.

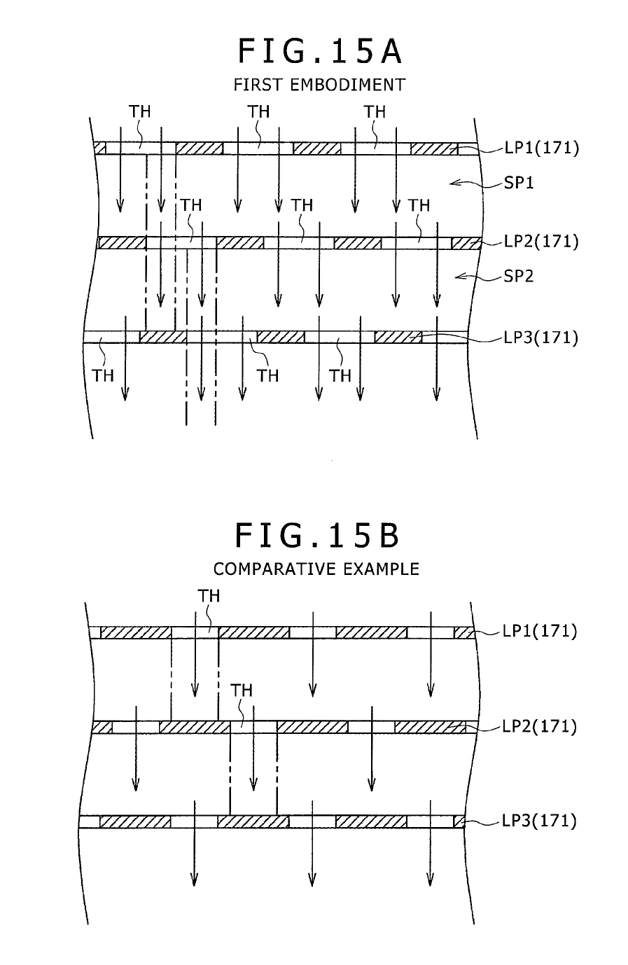

In this embodiment, as the opening in the wound plate pack 170, multiple through holes TH are further provided to expand the total square measure of the opening in the wound plate pack 170. With reference to FIG. 14 and FIGS. 15A and 15B, the flow of the electrolyte infiltrating into the wound plate pack 170 will be described. FIG. 14 is a partially enlarged sectional schematic diagram showing Part A1 and Part A2 of FIG. 11, and FIG. 15 are conceptual diagrams showing the flow of electrolyte passing the through holes. In FIG. 14 and FIG. 15, the flow of the electrolyte passing the through holes TH is schematically represented by arrows. Incidentally, as the flow of the electrolyte on the negative electrode side is similar to the flow of the electrolyte on the positive electrode side, the flow of the electrolyte passing the through holes TH in the positive foil 171 will be described as also representing the flow of the electrolyte passing the through holes TH in the negative foil 172, whose particular description will be dispensed with.

In FIG. 15, the positive foil 171 constituting the external circumferential face of the wound plate pack 170 is shown as a first layer LP1, the positive foil 171 one layer inside of the first layer LP1 as a second layer LP2, and the positive foil 171 one layer inside of the second layer LP2 as a third layer LP3. Incidentally, though only the first layer LP1 through the third layer LP3 are shown on an enlarged scale in FIG. 15, in reality tens of layers of the positive foils 171 are arranged.

FIG. 15A shows this embodiment in which the through holes TH are so arrayed that the holes overlap each other in adjoining layers, while FIG. 15B shows as a comparative example a modified version of the first embodiment in which the through holes TH are so arrayed that the holes do not overlap each other in adjoining layers.

As shown in FIG. 15A, the electrolyte filling a gap between the internal face of the battery container and the wound plate pack 170 flows from the through holes TH in the first layer LP1 into a first space SP1 between the first layer LP1 and the second layer LP2. The electrolyte having flowed into the first space SP1 flows from the first space SP1 into a second space SP2 between the second layer LP2 and the third layer LP3. As the through holes TH are so arrayed that the holes overlap each other in adjoining layers, the electrolyte flow more smoothly toward the center of the wound plate pack 170 in the thickness direction than in the comparative example in which the through holes TH are so arrayed that the holes do not overlap each other in adjoining layers (see FIG. 15B).

Incidentally, the secondary battery 100 may be heated by overcharging or short-circuiting and invite generation of high temperature gas within. The gas generated within the wound plate pack 170 is discharged out of the wound plate pack 170 through the opening of the wound plate pack 170. Thus the through holes TH described above function as not only an inlet for the electrolyte but also as a release vent for discharging out of the wound plate pack 170 any gas generated in the wound plate pack. For this reason, there has been a desire to enhance the gas discharging performance by expanding the opening of the wound plate pack 170. In this embodiment, by providing multiple through holes TH, the square measure of the opening of the wound plate pack 170 is expanded, and as a result any gas generated in the wound plate pack 170 is quickly discharged out of the wound plate pack 170.

This embodiment described so far can give the following advantageous effects.

(1) Multiple through holes TH are formed in the winding direction between joining parts in the positive electrode uncoated part 176b with the positive current collector 180 and the positive electrode coated part 176a. Also, multiple through holes TH are formed in the winding direction between joining parts in the negative electrode uncoated part 177b with the negative current collector 190 and the negative electrode coated part 177a. By providing the multiple through holes TH, the total square measure of the opening of the wound plate pack 170 is expanded.

As the electrolyte injected through the liquid filling hole 106a of the battery container infiltrates into the wound plate pack 170 through the opening of the wound plate pack 170 having multiple through holes TH, the electrolyte can impregnate the whole internal area of the wound plate pack 170 in a shorter period of time than according to the known related art having no through holes TH. As a result, the time taken to inject the electrolyte can be shortened, and accordingly the productivity of the secondary battery 100 can be enhanced.

(2) The opening of the wound plate pack 170 also functions as a gas release route for any gas generated within the wound plate pack 170. In this embodiment, as the total square measure of the opening of the wound plate pack 170 is expanded by the presence of the through holes TH, any gas generated within the wound plate pack 170 can be quickly discharged out of the wound plate pack 170. Rises in the internal temperature and the internal pressure in the wound plate pack 170 can be restrained, and spouting of high-temperature high-pressure gas through the opening of the wound plate pack 170 can be prevented, resulting in enhanced safety of the secondary battery 100.

(3) The through holes TH provided in the positive and negative electrode uncoated parts 176b and 177b of the wound plate pack 170 are so arrayed in the winding direction that the holes overlap each other in adjoining layers (see FIG. 13 and FIG. 15A). As a result, it can let the electrolyte more smoothly flow into the wound plate pack 170 to cause the electrolyte to impregnate the whole inside area of the wound plate pack 170 in a shorter period of time than the wound plate pack pertaining to the comparative example in which the multiple through holes TH are so arrayed in the winding direction that the holes do not overlap each other in adjoining layers (see FIG. 15B).

(4) The through holes TH have such an elliptical shape that the longer dimensional direction of the through holes TH is parallel to the winding direction and the shorter dimensional direction of the through holes TH is orthogonal to the winding direction. This shape serves, in the manufacturing process of the wound plate pack 170, to ease stress concentration attributable to tensions working on the positive foil 171 and the negative foil 172.

(5) According to the conventional related art, prescribed lengths are secured as parts to be curved in forming the bundled positive and negative electrode junctions 178 and 179 between joining parts with the positive current collector 180 in the positive electrode uncoated part 176b and the positive electrode coated part 176a and between joining parts with the negative current collector 190 in the negative electrode uncoated part 177b and the negative electrode coated part 177a. In the secondary battery 100 of this embodiment, this part is provided as the hole punching area 12b, and there is no need to extend the lengths of the positive foil 171 and the negative foil 172 in the shorter side direction beyond the conventional lengths in order to provide the through holes TH. Namely, this embodiment enables the total area of the opening of the wound plate pack 170 to be expanded while maintaining the compactness of the secondary battery 100.

### Second Embodiment

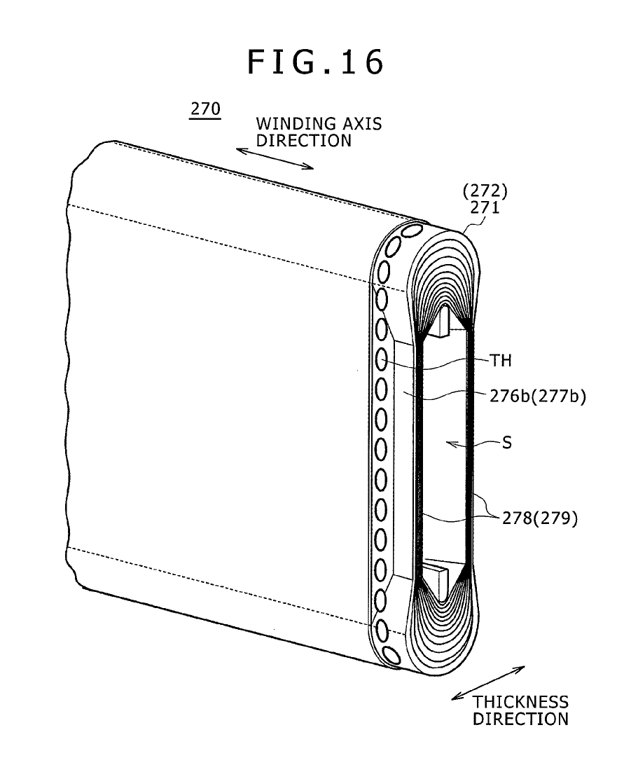

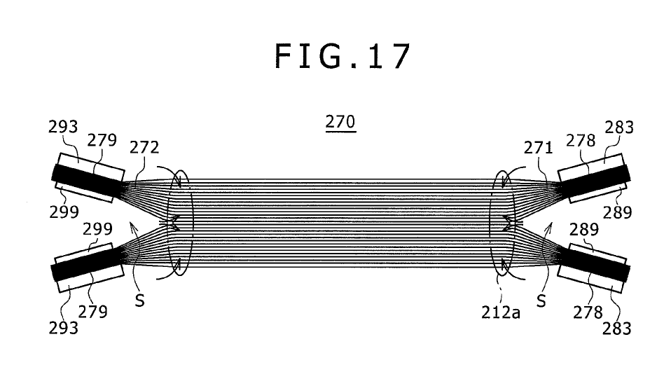

A secondary battery, which is a second embodiment of the invention, will be described with reference to FIG. 16 and FIG. 17. FIG. 16 is a perspective view showing a wound plate pack 270 to be housed in a battery container of a secondary battery, which is the second embodiment of the invention and FIG. 17, a planar sectional schematic diagram of the wound plate pack 270, wherein the flow of the electrolyte is schematically represented by arrows. In FIG. 16, while the configuration of the positive electrode side is shown, as the negative electrode side is similarly shaped, reference numerals of constituent elements on the negative electrode side are parenthesized for the sake of convenience. To add, similar parts to what are present in the first embodiment are assigned three-digit reference numerals beginning with 2, instead of 1, and the next two digits are common between the two embodiments. The following description will mainly concern differences from the first embodiment.

In the second embodiment, the shape of bundled positive and negative electrode junctions 278 and 279 formed on the two ends of the wound plate pack 270 fabricated through the manufacturing process described with, reference to the first embodiment (FIG. 6 through FIG. 9) differ from the first embodiment. In the second embodiment, as shown in FIG. 16 and FIG. 17, a pair of bundled positive electrode junctions 278 are formed by so crushing in advance the stacked part of a positive electrode uncoated part 276b disposed at one end of the wound plate pack 270 as to be bisected and compressed in the thickness direction. Similarly, a pair of negative electrode junctions 279 are formed by so crushing in advance the stacked part of a negative electrode uncoated part 277b disposed at the other end of the wound plate pack 270 as to be bisected and compressed in the thickness direction.

As shown in FIG. 17, a joining plate 283 of a positive current collector 280 is ultrasonically joined to the bundled positive electrode junctions 278, and a joining plate 293 of a negative current collector 290 is ultrasonically joined to the bundled negative electrode junctions 279. When joining the bundled positive electrode junctions 278 with the positive current collector 280, a rectangular flat protective plate 289 is used to prevent a positive foil 271 from being damaged. When the bundled negative electrode junction 279 and the negative current collector 290 are to be joined, a rectangular flat protective plate 299 is used to prevent a negative foil 272 from being damaged.

Multiple through holes TH punched in the positive foil 271 are positioned, as shown in FIG. 17, between a flat part of the wound plate pack 270 and a curved part of the bundled positive electrode junctions 278. In this embodiment, the multiple through holes TH in the positive foil 271 are arrayed, as schematically represented by two-dot chain lines in FIG. 17, in the winding direction in a range 212p near the flat part of the wound plate pack 270.

Similarly, a flat part of through holes TH punched in the negative foil 272 are positioned, as shown in FIG. 17, in a curved part between the flat part of the wound plate pack 270 and the curved part of the bundled negative electrode junctions 279. In this embodiment, the multiple through holes TH in the negative foil 272 are arrayed, as schematically represented by two-dot chain lines in FIG. 17, in the winding direction in a range 212n near the flat part of the wound plate pack 270.

Such a secondary battery of the second embodiment can provide similar advantageous effects to the first embodiment.

Furthermore in the second embodiment, as the pair of bundled positive electrode junctions 278 and the pair of bundled negative electrode junctions 279 are formed by so crushing the stacked parts of the positive and negative electrode uncoated parts 276b and 277b as to be bisected, a space S is formed between the pair of bundled positive electrode junctions 278 and between the pair of bundled negative electrode junctions 279.

As a result, when electrolyte is injected, the electrolyte infiltrates into the wound plate pack 270 through the through holes TH in the positive and negative foils 271 and 272 on the side of the wide faces 101a of the battery case 101 and the through holes TH in the positive and negative foils 271 and 272 on the space S side. For this reason, the whole internal area of the wound plate pack 270 can be impregnated with the electrolyte more quickly than in the first embodiment. Further, any gas generated within the wound plate pack 270 can be discharged out of the wound plate pack 270 more quickly.

To add, the following modification is also possible within the scope of the present invention, and it is also conceivable to combine one or more of modified versions with the embodiment or embodiments described above.

### Modified Version

(1) Although the through holes TH are supposed to be elliptically shaped in the foregoing embodiments, the invention is not limited to this. Various other shapes, such as circular and polyprismatic shapes, can be adopted. As it is possible to ease stress concentration by using a shape having no angular part, it is more preferable to use a circular shape or an elliptical shape than to use a polyprismatic shape.

(2) Although the embodiments described above suppose arraying of the multiple through holes TH in one row in the winding direction in each of the positive and negative electrode uncoated parts 176b, 177b, 276b, and 277b, the invention is not limited to this, but the holes can as well be arranged in multiple rows. When the multiple rows of through holes TH are to be arrayed, the layout may as well be zigzag or checkered.

(3) In the foregoing embodiments, the shape of the battery container is supposed to be prismatic, but the invention is not limited to this. It may be a flat battery container having an elliptical section, or various thin battery containers whose battery case opening is sealed with a battery lid are also available for choice.

(4) Although a lithium ion secondary battery is cited as one example, the invention is also applicable to various other secondary battery types including a nickel hydrogen battery.

(5) The material of the positive terminal 141, the positive current collector 180, and the positive foils 171 and 271 is not limited to aluminum, but may as well be aluminum alloy. The material of the negative terminal 151, the negative current collector 190, and the negative foils 172 and 272 is not limited to copper, but may as well be copper alloy.

The present invention is not limited to the foregoing embodiments, but can be freely modified or improved within the range of not deviating from the essentials thereof.

What is claimed is:

1. A secondary battery comprising:
a wound plate pack formed by winding, with a separator intervening in-between, a positive electrode provided with a positive electrode coated part having a long positive foil coated with positive electrode active material and a positive electrode uncoated part and a negative electrode provided with a negative electrode coated part having a long negative foil coated with negative electrode active material and a negative electrode uncoated part;
a battery container which houses the wound plate pack and into which electrolyte is injected;
a positive terminal and a negative terminal provided on the battery container;
a positive current collector that connects the positive electrode uncoated part and the positive terminal; and
a negative current collector that connects the negative electrode uncoated part and the negative terminal,
wherein a plurality of through holes are formed in a winding direction between a joining part with the positive current collector in the positive electrode uncoated part and the positive electrode coated part; and
wherein a plurality of through holes are formed in the winding direction between a joining part with the negative current collector in the negative electrode uncoated part and the negative electrode coated part.

2. The secondary battery as claimed in claim 1,
wherein the through holes punched in the positive and negative electrode uncoated parts of the wound plate pack are so arrayed in the winding direction that the through holes overlap each other in adjoining layers.

3. The secondary battery as claimed in claim 2,
wherein the length of the through holes, provided in the positive and negative foils, in the winding direction is greater than the length of the positive and negative foils located between a pair of through holes adjoining each other in the winding direction.

4. The secondary battery as claimed in claim 3,
wherein the through holes are in an elliptical shape of which the longer side direction is parallel, and the shorter side direction is orthogonal, to the winding direction.
